(19) United States
(12) Patent Application Publication
(10) Pub. No.: US 2017/0213669 A1
(43) Pub. Date: Jul. 27, 2017

(54) MOUSE WITH TUNABLE LEFT/RIGHT SWITCHES

(71) Applicant: Corsair Memory, Inc., Fremont, CA (US)

(72) Inventor: Aliex Su, Fremont, CA (US)

(21) Appl. No.: 15/415,816

(22) Filed: Jan. 25, 2017

Related U.S. Application Data
(60) Provisional application No. 62/286,928, filed on Jan. 25, 2016.

(51) Int. Cl. H01H 19/00; H01H 13/36; H01H 13/14; G06F 3/0354; H01H 19/08

(52) U.S. Cl. CPC H01H 19/003; G06F 3/03543; H01H 19/08; H01H 13/14; H01H 13/36

(57) ABSTRACT

A computer mouse that includes a plurality of tunable switch assemblies is disclosed. According to certain embodiments, the tunable switch assembly comprises a plurality of tunable switches and a rotatable wheel casing that houses the plurality of tunable switches. Each tunable switch of the plurality of tunable switches is distinct from any other tunable switch in the plurality of tunable switches in a given tunable switch assembly of the plurality of tunable switch assemblies, according to certain embodiments.

### CROSS-REFERENCE TO RELATED APPLICATIONS

The present application claims the benefit of U.S. Provisional Patent Application Ser. No. 62/286,928, filed Jan. 25, 2016 and entitled “Mouse with Tunable Left/Right Switches,” which is hereby incorporated by reference in its entirety.

### TECHNICAL FIELD

The present invention is directed to accessories for computers, and more specifically to aspects of a computer mouse.

### BRIEF DESCRIPTION OF THE DRAWINGS

For a better understanding of the various embodiments of the invention, reference should be made to the description of embodiments below, in conjunction with the following drawings in which like reference numerals refer to corresponding parts throughout the figures.

FIG. 1 illustrates a top view of the exterior of a computer mouse, according to certain embodiments.

FIG. 2 illustrates a left side perspective view of the exterior of a computer mouse, according to certain embodiments.

FIG. 3 illustrates a right side perspective view of the exterior of a computer mouse, according to certain embodiments.

FIG. 4 illustrates a left side view of some of the exterior and internal components of a computer mouse, according to certain embodiments.

FIG. 5 illustrates a left side view of some of the exterior and internal components of a computer mouse, according to certain embodiments.

FIG. 6 illustrates a left side view of some of the exterior and internal components of a computer mouse, according to certain embodiments.

FIG. 7 illustrates a front exploded perspective view of a tunable switch assembly of a computer mouse, according to certain embodiments.

FIG. 8 illustrates a rear exploded perspective view of the tunable switch assembly of FIG. 7, according to certain embodiments.

FIG. 9A illustrates a top perspective view of tunable switch assembly, according to certain embodiments.

FIG. 9B illustrates a top view of tunable switch assembly 910, according to certain embodiments.

FIG. 9C illustrates a left side view of tunable switch assembly 910, according to certain embodiments.

FIG. 9D illustrates a front view of tunable switch assembly 910, according to certain embodiments.

FIG. 9E illustrates a right side view of tunable switch assembly 910, according to certain embodiments.

FIG. 9F illustrates a bottom view of tunable switch assembly 910, according to certain embodiments.

FIG. 9G illustrates a bottom perspective view of tunable switch assembly 910, according to certain embodiments.

FIG. 10A illustrates a top perspective view of a tunable switch assembly that shows the some of the mechanics of changing the switch settings associated with a click button, according to certain embodiments.

FIG. 10B illustrates an enlarged side perspective view of a sheet metal spring, according to certain embodiments.

FIG. 10C illustrates an enlarged side-front perspective view of a sheet metal spring, according to certain embodiments.

FIG. 10D illustrates an enlarged rear perspective view of a sheet metal spring, according to certain embodiments.

FIG. 11 illustrates a front perspective view of a tunable switch assembly that shows the selection of a switch setting, according to certain embodiments.

FIG. 12A, FIG. 12B, FIG. 12C, FIG. 12D, FIG. 12E, and FIG. 12F illustrate the workings of some components of a tunable wheel assembly, according to certain embodiments.

FIG. 13A, FIG. 13B, FIG. 13C, FIG. 13D, FIG. 13E, and FIG. 13F illustrate the workings of some components of a tunable wheel assembly, according to certain embodiments.

FIG. 14A, FIG. 14B, FIG. 14C, FIG. 14D, FIG. 14E, and FIG. 14F illustrate the workings of some components of a tunable wheel assembly, according to certain embodiments.

### DETAILED DESCRIPTION

Methods, systems, user interfaces, and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

According to certain embodiments, a computer mouse includes different types of switches for its right and left buttons (also referred to as right/left click buttons). Pressing down on the right button is referred to as a “right-click”. Pressing down on the left button is referred to as a “left-click”. As a non-limiting example, the computer mouse includes a set of N number of switch types for the “right-click” button as well as for the “left-click” button. According to certain embodiments, the computer mouse design is such that any one of the N number of switch types can be selected for use by moving the given switch into position underneath the right click button, and/or the left click button.

According certain embodiments, each set of N number of switches are housed in a rotatable wheel case such that a given switch that is selected for use from the set of switches can be rotated into position for use by rotating the rotatable wheel case. In this manner, any switch from the set of switches housed in a rotatable wheel case can be rotated in and out of the operational position at the pleasure of a user.

According to certain embodiments, each type of switch has a specific tactile characteristic. For example, when a user presses on a given click button (either right or left click), the post beneath the given click button impinges on the switch. Depending on the type of switch, the switch imparts a certain tactile feel to the user's finger as the user presses down on the click button using her/his finger. For example, the tactile feel can be of a linear nature or a non-linear nature.

According to certain embodiments, each switch type includes at least a subset of the following non-limiting example of characteristics that create a tactile and/or auditory effect: 1) total travel distance, 2) operating distance, 3) operating force, 4) sound effects, 5) linear tactile feel, 6) non-linear tactile feel, and 7) click-ratio.

According to certain embodiments, some of the characteristics that create a tactile effect associated with a given type of switch can include at least a subset of: 1) switch stem length, 2) switch spring force, 3) switch stem foot shape and slope, 4) position of switch stem foot on switch stem, and 5) position of travel limit stopper.

Non-limiting examples of types of switches include: 1) A-type stem switch, 2) B-type stem switch, 3) C-type stem switch.

According to certain embodiments, an A-type stem switch includes the following characteristics:

Total travel distance is greater than 1.3 mm but less than 1.85 mm.
Operating point is greater than 0.6 mm but less than 0.85 mm.
Spring force is greater than 90 grams-force but less than 170 grams-force.

According to certain embodiments, an B-type stem switch includes the following characteristics:

Total travel distance is greater than 0.9 mm but less than 1.25 mm.
Operating point is greater than 0.45 mm but less than 0.7 mm.
Spring force is greater than 80 grams-force but less than 105 grams-force.

According to certain embodiments, an C-type stem switch includes the following characteristics:

Total travel distance is greater than 0.7 mm but less than 1.1 mm.
Operating point is greater than 0.25 mm but less than 0.4 mm.
Spring force is greater than 120 grams-force but less than 190 grams-force.

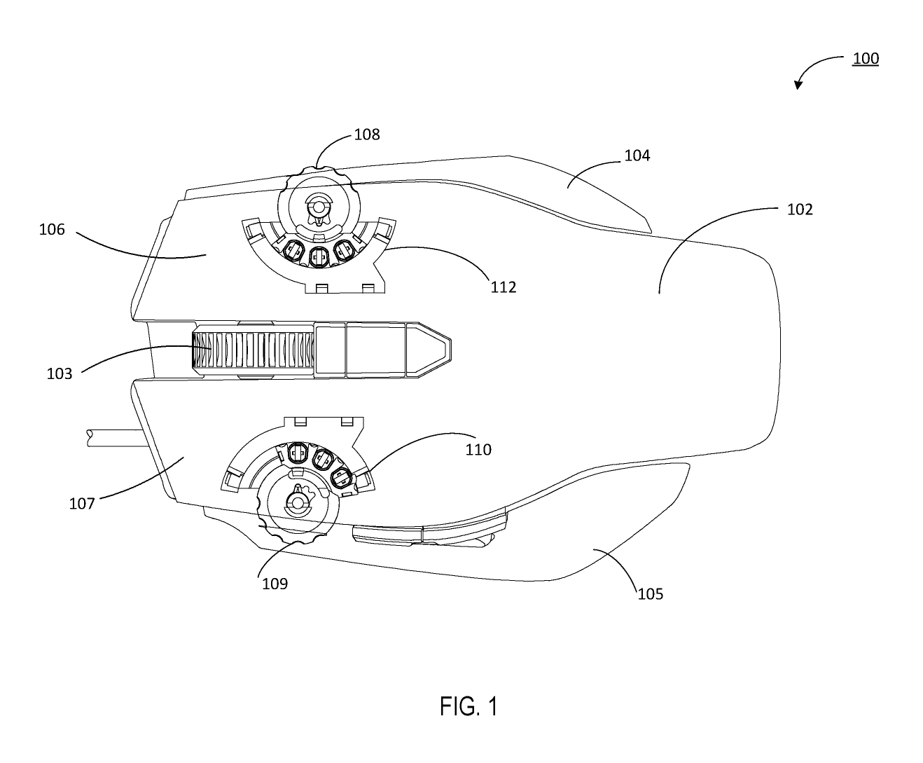

FIG. 1 illustrates a top view of the exterior of a computer mouse, according to certain embodiments. The embodiments are not restricted to the shape of the computer mouse shown in FIG. 1. The purpose of FIG. 1 is to provide context for the description of the left and right click buttons and associated switches of the computer mouse. To explain, the tunable click assemblies described herein can be used in a variety of types and shapes of computer mouse, and can vary from implementation to implementation. FIG. 1 shows a top exterior cover 102, a scroll wheel 103, a right side cover 104, a left side cover 105, a right-click button 106, and a left-click button 107 of a computer mouse 100. For ease of explanation of FIG. 1, assume the top exterior cover 102 is transparent in order to reveal a right-click tunable switch assembly 112 and a left-click tunable switch assembly 110, according to certain embodiments. Other interior components of computer mouse 100 are not shown in order not to obscure the view of the tunable switch assemblies. FIG. 1 also shows a right rotatable wheel 108 associated with right-click tunable switch assembly 112, according to certain embodiments. A portion of right rotatable wheel 108 is accessible through an aperture on the right side cover 104. Similarly, a left rotatable wheel 109 associated with left-click tunable switch assembly 110, according to certain embodiments. A portion of left rotatable wheel 109 is accessible through an aperture on the left side cover 105, according to certain embodiments. The tunable switch assemblies are described in greater detail herein.

According to certain embodiments, a computer mouse may incorporate only one tunable switch assembly. For example, only one of the click buttons on the computer mouse incorporates the tunable switch assembly.

According to certain other embodiments, a computer mouse may incorporate multiple tunable switch assemblies. For example, the computer mouse may have more than 2 click buttons. In such a case, one or more of the more than 2 click buttons can each incorporate a tunable switch assembly. The number of click buttons that incorporate tunable switch assemblies may vary from implementation to implementation.

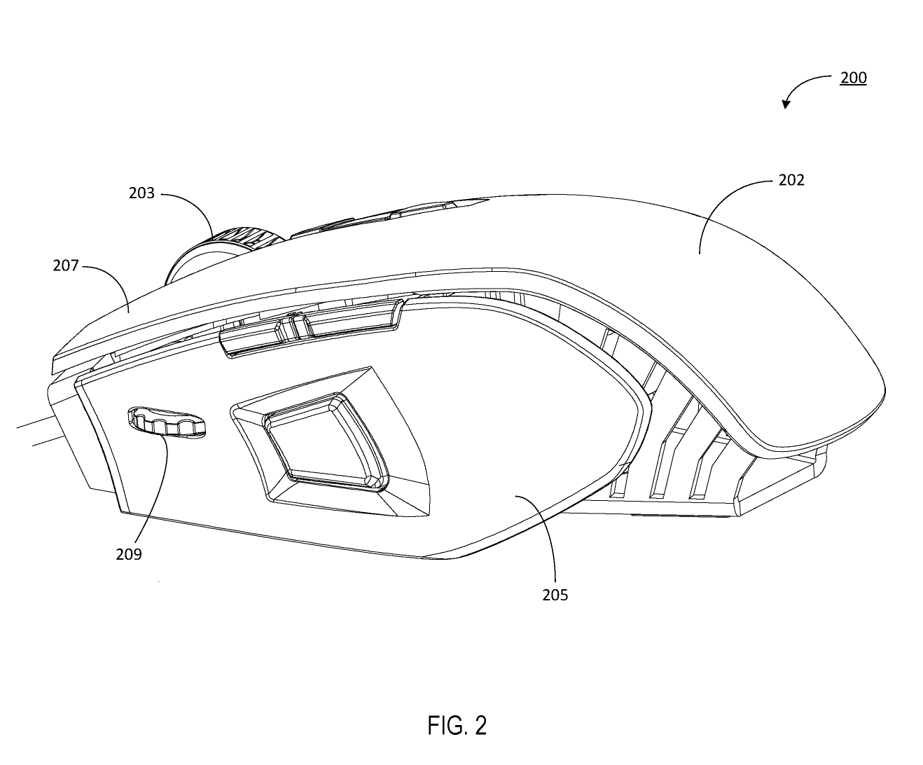

FIG. 2 illustrates a left side perspective view of the exterior of a computer mouse, according to certain embodiments. The embodiments are not restricted to the shape of the computer mouse shown in FIG. 2. FIG. 2 provides context for describing the right/left click tunable assemblies that can be incorporated into a computer mouse. FIG. 2 shows a top exterior cover 202, a scroll wheel 203, a left side cover 205, a left-click button 207 (a right-click button of the computer mouse is not visible in FIG. 2), and a left rotatable wheel 209 (associated with left-click tunable switch assembly not shown in FIG. 2) of the computer mouse 200. A user can rotate left rotatable wheel 209 to change switch settings of the associated left-click tunable switch assembly as described in greater detail herein.

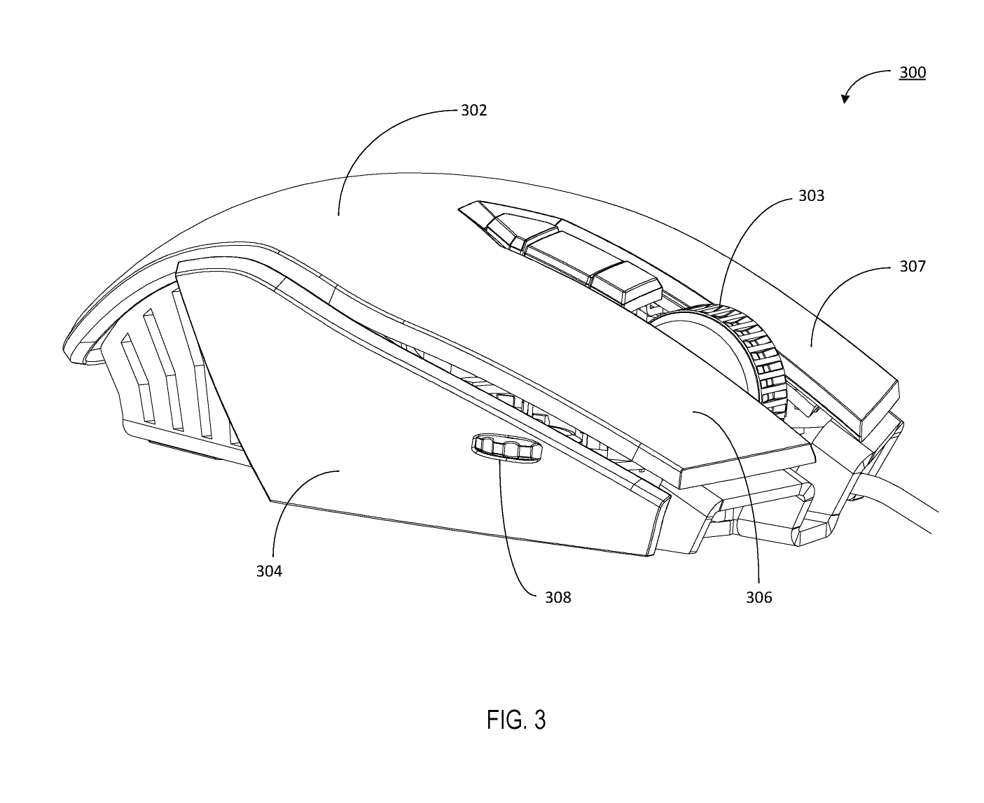

FIG. 3 illustrates a right side perspective view of the exterior of a computer mouse, according to certain embodiments. The embodiments are not restricted to the shape of the computer mouse shown in FIG. 3. FIG. 3 provides context for describing the right/left click tunable assemblies that can be incorporated into a computer mouse. FIG. 3 shows a top exterior cover 302, a scroll wheel 303, a right side cover 304, a left-click button 307, a right-click button 306, and a right rotatable wheel 308 (associated with right-click tunable switch assembly not shown in FIG. 3) of the computer mouse 300. A user can rotate right rotatable wheel 308 to change switch settings of the associated right-click tunable switch assembly as described in greater detail herein.

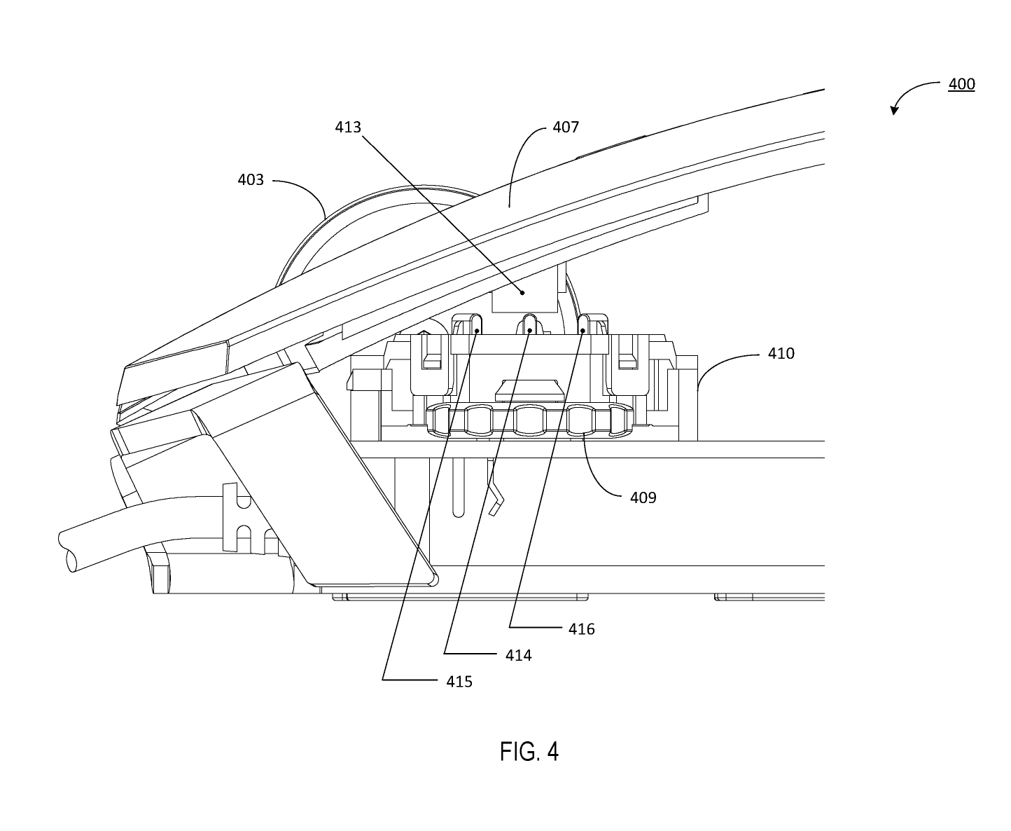

FIG. 4 illustrates a left side view of some of the exterior and internal components of a computer mouse, according to certain embodiments. FIG. 4 shows a scroll wheel 403, and a portion of a left-click button 407 of a computer mouse 400. In FIG. 4, the left side cover is removed to show some of the internal components of computer mouse 400. FIG. 4 shows a left-click post 413 (associated with left-click button 407), a left-click tunable switch assembly 410, a left rotatable wheel 409 (associated with left-click tunable switch assembly 410), according to certain embodiments. FIG. 4 also shows that left-click tunable switch assembly 410 includes various types of stem switches such as an A-type stem switch 414, a B-type stem switch 415, and a C-type stem switch 416, according to certain embodiments. FIG. 4 shows that the A-type stem switch 414 is rotated into position (e.g., by rotating left rotatable wheel 409) such that A-type stem switch 414 is beneath left click post 413. Thus, the left-click button 407, when pressed, causes left-click post 413 to impinge on A-type stem switch 414, according to certain embodiments.

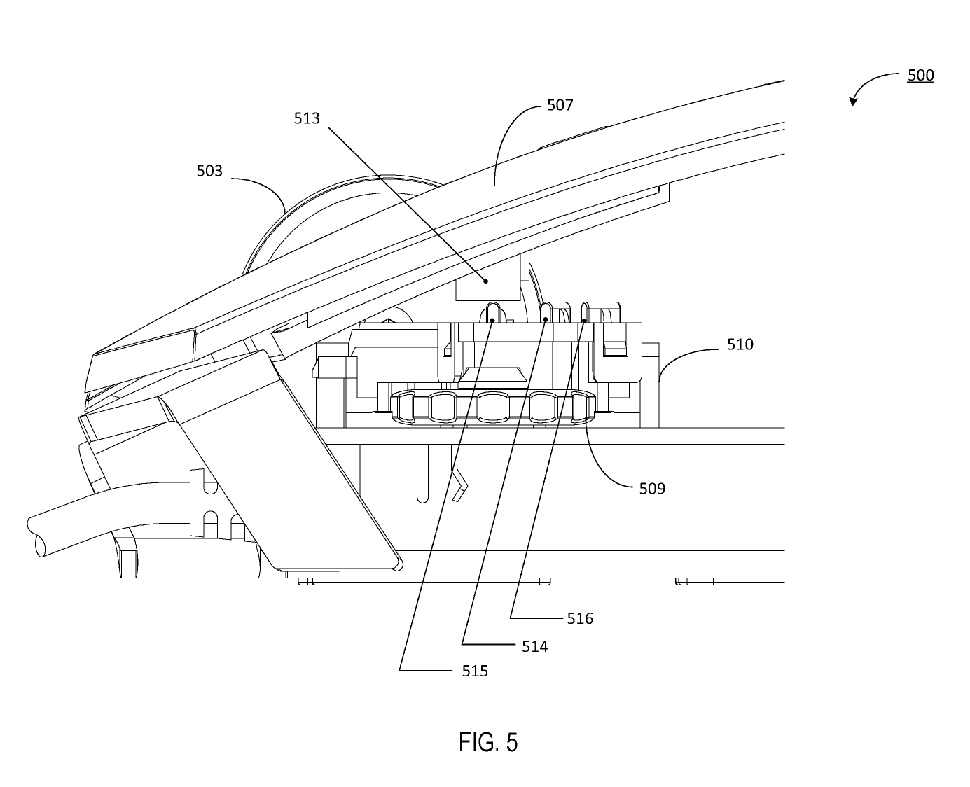

FIG. 5 illustrates a left side view of some of the exterior and internal components of a computer mouse, according to certain embodiments. FIG. 5 shows a scroll wheel 503, and a portion of a left-click button 507 of a computer mouse 500. In FIG. 5, the left side cover is removed to show some of the internal components of computer mouse 500. FIG. 5 shows a left-click post 513 (associated with left-click button 507), a left-click tunable switch assembly 510, a left rotatable wheel 509 (associated with left-click tunable switch assembly 510), according to certain embodiments. FIG. 5 also shows that left-click tunable switch assembly 510 includes various types of stem switches such as an A-type stem switch 514, a B-type stem switch 515, and a C-type stem switch 516, according to certain embodiments. FIG. 5 shows that the B-type stem switch 515 is rotated into position (e.g., by rotating left rotatable wheel 509) such that B-type stem switch 515 is beneath left click post 513. Thus, the left-click button 507, when pressed, causes left click post 513 to impinge on B-type stem switch 515, according to certain embodiments.

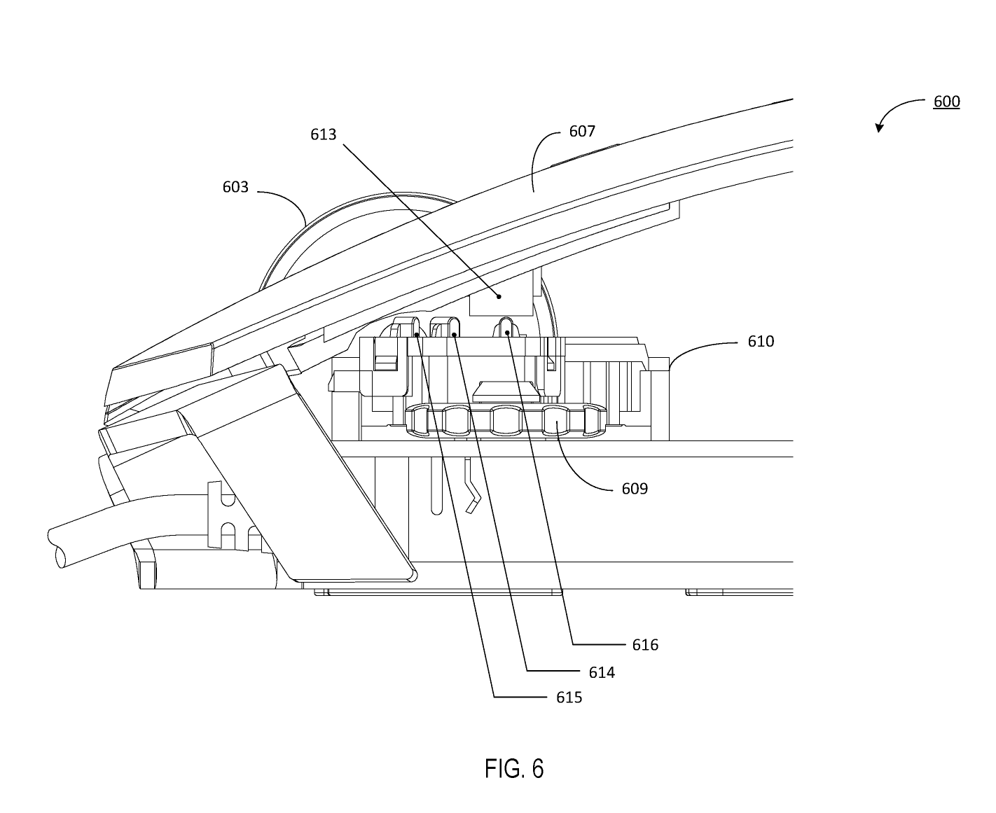

FIG. 6 illustrates a left side view of some of the exterior and internal components of a computer mouse, according to certain embodiments. FIG. 6 shows a scroll wheel 603, and a portion of a left-click button 607 of a computer mouse 600. In FIG. 6, the left side cover is removed to show some of the internal components of computer mouse 600. FIG. 6 shows a left-click post 613 (associated with left-click button 607), a left-click tunable switch assembly 610, a left rotatable wheel 609 (associated with left-click tunable switch assembly 610), according to certain embodiments. FIG. 6 also shows that left-click tunable switch assembly 610 includes various types of stem switches such as an A-type stem switch 614, a B-type stem switch 615, and a C-type stem switch 616, according to certain embodiments. FIG. 6 shows that the C-type stem switch 616 is rotated into position (e.g., by rotating left rotatable wheel 609) such that C-type stem switch 616 is beneath left click post 613. Thus, the left-click button 607, when pressed, causes left click post 613 to impinge on C-type stem switch 616, according to certain embodiments.

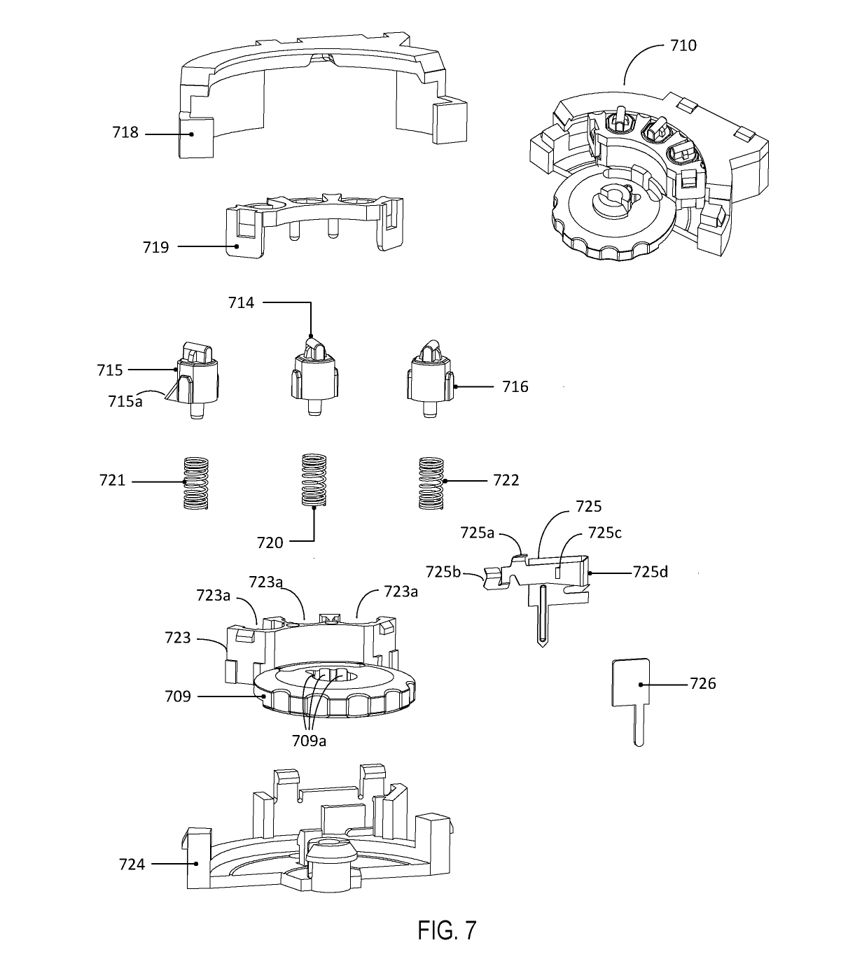

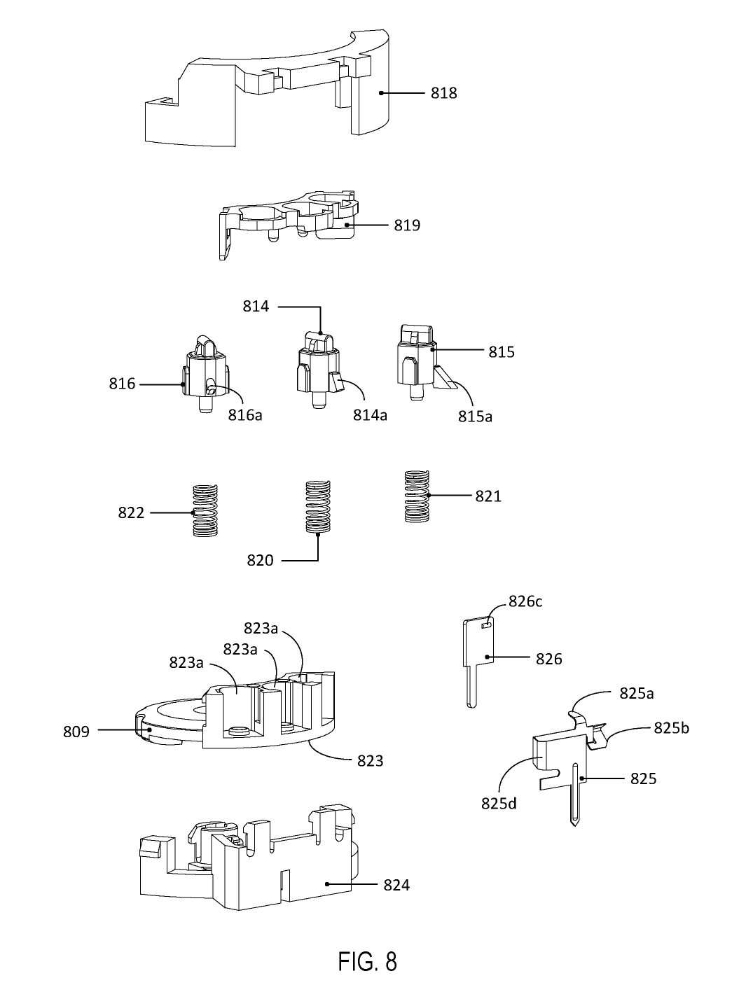

FIG. 7 illustrates a front exploded perspective view of a tunable switch assembly 710 of a computer mouse, according to certain embodiments. Such a tunable switch assembly can be used with a click button of the computer mouse. FIG. 7 shows a chassis 718, a stem cover 719, an A-type stem switch 714 (its associated stem foot is not visible in FIG. 7 but is visible in FIG. 8 herein), a B-type stem switch 715 (and associated stem foot 715a), and a C-type stem switch 716 (its associated stem foot is not visible in FIG. 7 but is visible in FIG. 8 herein), an A-type spring 720, a B-type stem spring 721, and a C-type spring 722, a rotatable wheel casing 723, a housing 724, a sheet metal spring 725 and a contact pin 726, according to certain embodiments. Rotatable wheel casing 723 includes a rotatable wheel 709 with slots 709a for an associated locking tooth, and stem slots 723a, according to certain embodiments. Sheet metal spring 725 includes a spring arm 725d, a contact portion 725c (for making contact with a corresponding contact portion on contact pin 726), an upper ear 725a (for contacting the stem cover) and a lower ear 725b (for contacting the stem foot of a given stem switch).

FIG. 8 illustrates a rear exploded perspective view of the tunable switch assembly of FIG. 7, according to certain embodiments. Such a tunable switch assembly can be used with a click button of the computer mouse. FIG. 8 shows a chassis 818, a stem cover 819, an A-type stem switch 814 (and associated stem foot 814a), a B-type stem switch 815 (and associated stem foot 815a), and a C-type stem switch 816 (and associated stem foot 816a), an A-type spring 820, a B-type stem spring 821, and a C-type spring 822, a rotatable wheel casing 823, a housing 824, a sheet metal spring 825 and a contact pin 826, according to certain embodiments. Rotatable wheel casing 823 includes a rotatable wheel 809, and stem slots 823a, according to certain embodiments. Sheet metal spring 825 includes a spring arm 825d, an upper ear 825a and a lower ear 825b. Contact pin 826 includes a contact portion 826c for making contact with a corresponding contact portion on sheet metal spring 825.

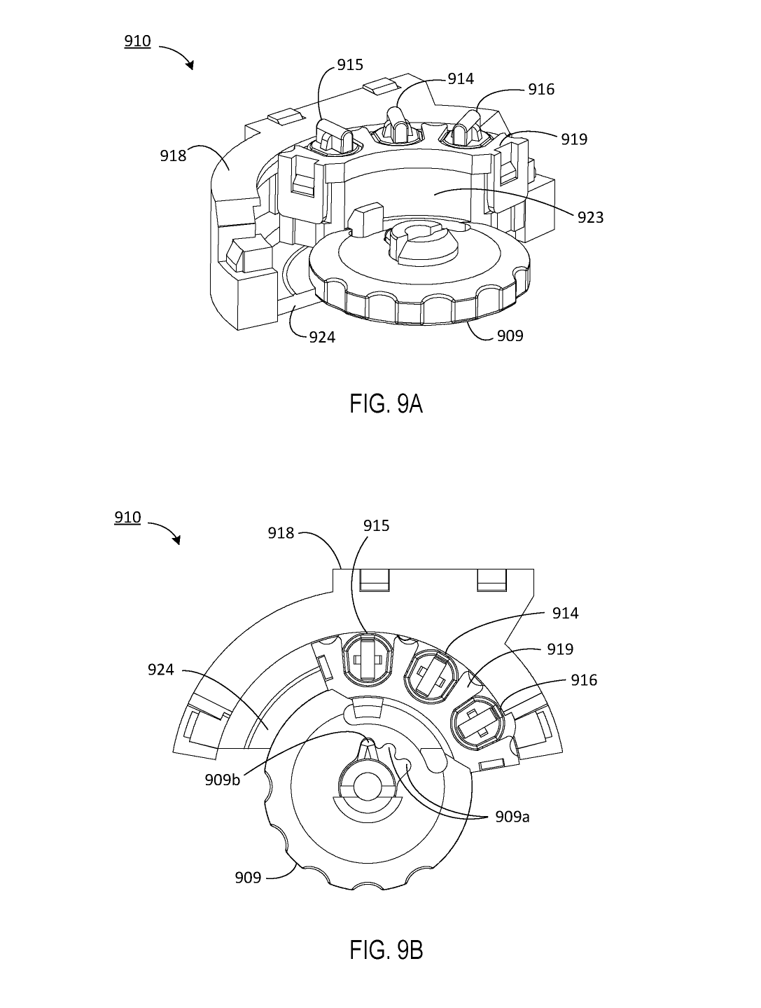

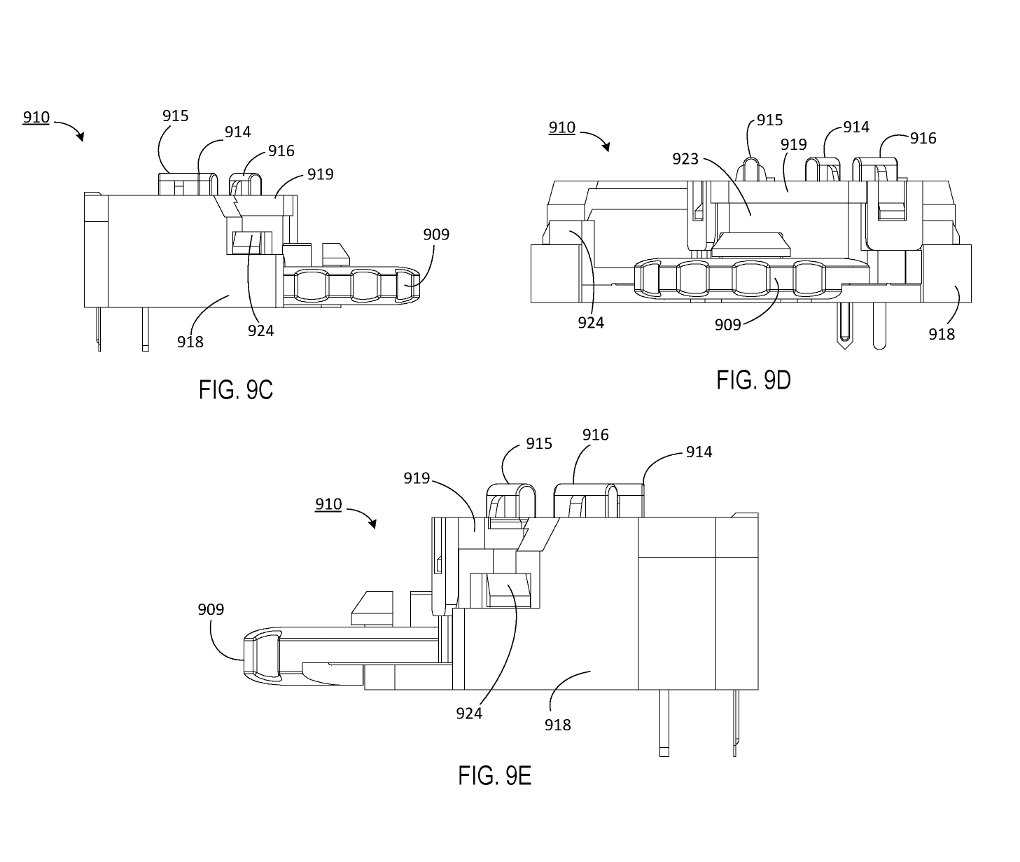

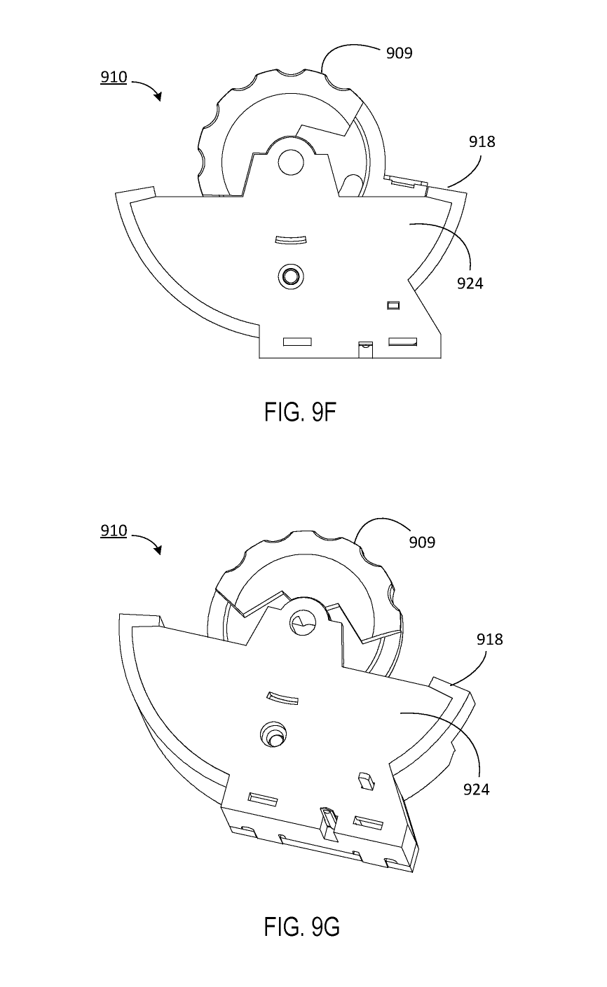

FIG. 9A illustrates a top perspective view of tunable switch assembly 910, according to certain embodiments. Such a tunable switch assembly can be used either with a click button of a computer mouse. FIG. 9A shows a chassis 918, a housing 924, a rotatable wheel casing 923, a rotatable wheel 909, a stem cover 919, an A-type stem switch 914, a B-type stem switch 915, and a C-type stem switch 916, according to certain embodiments.

FIG. 9B illustrates a top view of tunable switch assembly 910, according to certain embodiments. FIG. 9B shows a chassis 918, a housing 924, a stem cover 919, a rotatable wheel 909 (with slots 909a for an associated locking tooth 909b), an A-type stem switch 914, a B-type stem switch 915, and a C-type stem switch 916, according to certain embodiments.

FIG. 9C illustrates a left side view of tunable switch assembly 910, according to certain embodiments. FIG. 9C shows a chassis 918, a housing 924, a rotatable wheel 909, a stem cover 919, an A-type stem switch 914, a B-type stem switch 915, and a C-type stem switch 916, according to certain embodiments.

FIG. 9D illustrates a front view of tunable switch assembly 910, according to certain embodiments. FIG. 9D shows a chassis 918, a housing 924, a rotatable wheel casing 923, a rotatable wheel 909, a stem cover 919, an A-type stem switch 914, a B-type stem switch 915, and a C-type stem switch 916, according to certain embodiments.

FIG. 9E illustrates a right side view of tunable switch assembly 910, according to certain embodiments. FIG. 9E shows a chassis 918, a housing 924, a rotatable wheel 909, a stem cover 919, an A-type stem switch 914, a B-type stem switch 915, and a C-type stem switch 916, according to certain embodiments.

FIG. 9F illustrates a bottom view of tunable switch assembly 910, according to certain embodiments. FIG. 9F shows a chassis 918, a housing 924, and a rotatable wheel 909, according to certain embodiments.

FIG. 9G illustrates a bottom perspective view of tunable switch assembly 910, according to certain embodiments. FIG. 9G shows a chassis 918, a housing 924, a rotatable wheel 909, and housing 924, according to certain embodiments.

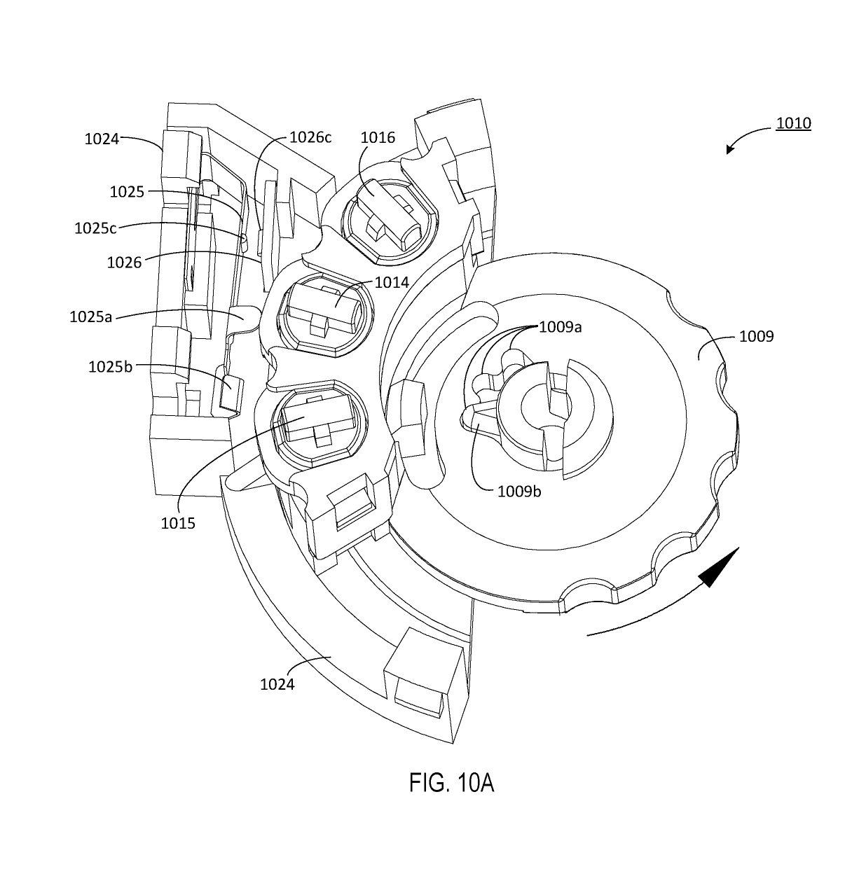

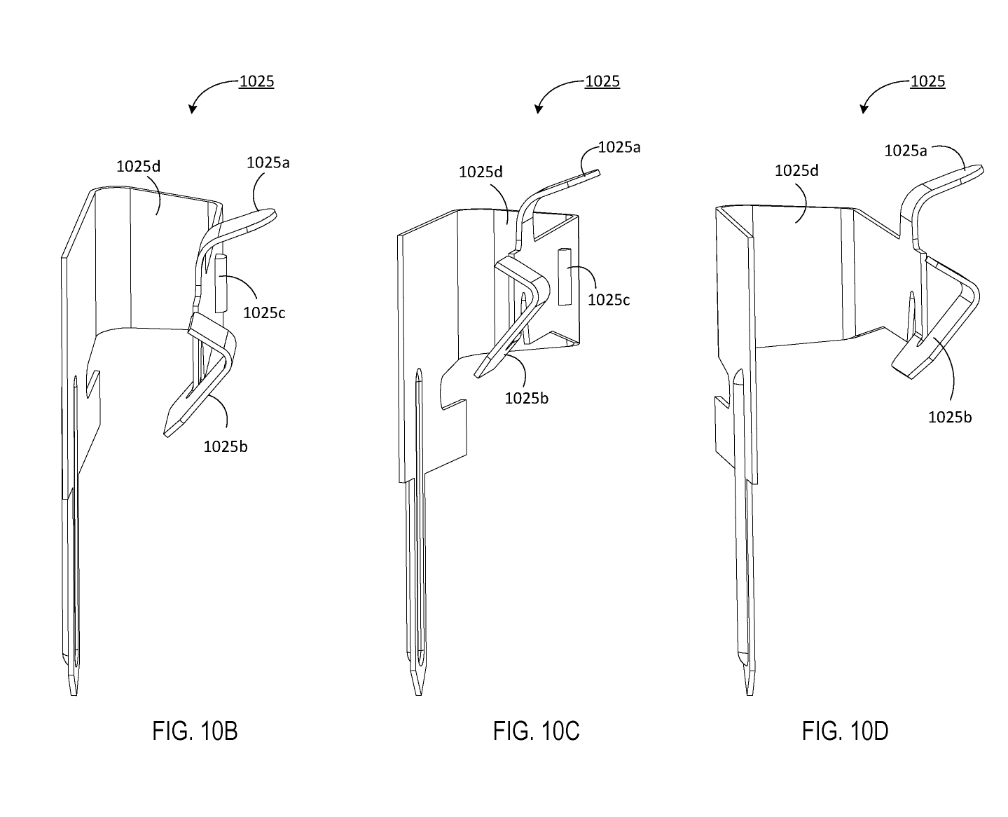

FIG. 10A illustrates a top perspective view of a tunable switch assembly that shows the some of the mechanics of changing the switch settings associated with a click button, according to certain embodiments. FIG. 10A shows a tunable wheel assembly 1010 with its chassis removed to reveal a sheet metal spring 1025 and a contact pin 1026. FIG. 10A also shows a housing 1024, a rotatable wheel casing 1023, a rotatable wheel 1009 (showing tooth slots 1009a and tooth 1009b in one of the tooth slots), a stem cover 1019, an A-type stem switch 1014, a B-type stem switch 1015, and a C-type stem switch 1016, according to certain embodiments. Rotatable wheel 1009 can be rotated in order to change the switch settings. Tooth 1009b locks the selected switch into position. FIG. 10A shows that tooth 1009b can be moved to the middle tooth slot by rotating rotatable wheel 1009. FIG. 10A also shows that an upper ear 1025a of sheet metal spring 1025 pushes against stem cover 1019 and thus prevents contact point 1025c associated with sheet metal spring 1025 from contacting contact point 1026c associated with contact pin 1026.

FIG. 10B illustrates an enlarged side perspective view of a sheet metal spring 1025, according to certain embodiments. FIG. 10B shows that sheet metal spring includes an upper ear 1025a, a lower ear 1025b, a contact point (surface) 1025c and a spring arm 1025d, according to certain embodiments.

FIG. 10C illustrates an enlarged side-front perspective view of a sheet metal spring 1025, according to certain embodiments. FIG. 10C shows that sheet metal spring includes an upper ear 1025a, a lower ear 1025b, a contact point (surface) 1025c and a spring arm 1025d, according to certain embodiments.

FIG. 10D illustrates an enlarged rear perspective view of a sheet metal spring 1025, according to certain embodiments. FIG. 10D shows that sheet metal spring includes an upper ear 1025a, a lower ear 1025b, and a spring arm 1025d, according to certain embodiments.

The embodiments are not restricted to the particular shape and material of the sheet metal spring as shown herein. What is important is the function that the sheet metal spring performs. One of the important purposes of the sheet metal spring is that the sheet metal spring prevents the contact point associated with sheet metal spring from contacting the corresponding contact point associated with the contact pin when a given selected stem switch is in the unpressed position. Thus, different embodiments may include different types of mechanisms to perform an equivalent function regarding contact points in the unpressed position.

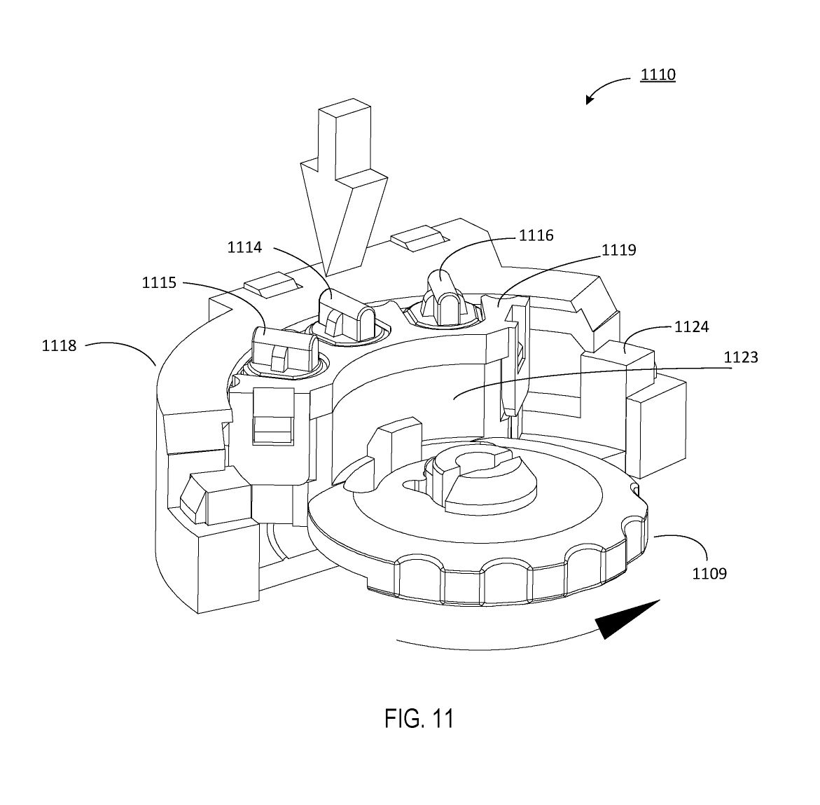

FIG. 11 Ilustrates a front perspective view of a tunable switch assembly that shows the selection of a switch setting, according to certain embodiments. FIG. 11 shows a chassis 1118, a housing 1124, a rotatable wheel casing 1123, a rotatable wheel 1109, a stem cover 1119, an A-type stem switch 1114, a B-type stem switch 1115, and a C-type stem switch 1116, according to certain embodiments. FIG. 11 shows that A-type stem switch 1114 is the selected switch setting positioned under the click button on the computer mouse. Thus, when the click button (not shown in FIG. 11) is pressed (1101b), the switch with A-type stem switch 1114 is activated. Thus, a user can select any of the switches (1114, 1115, 1116) to be positioned under the click button by rotating rotatable wheel 1109.

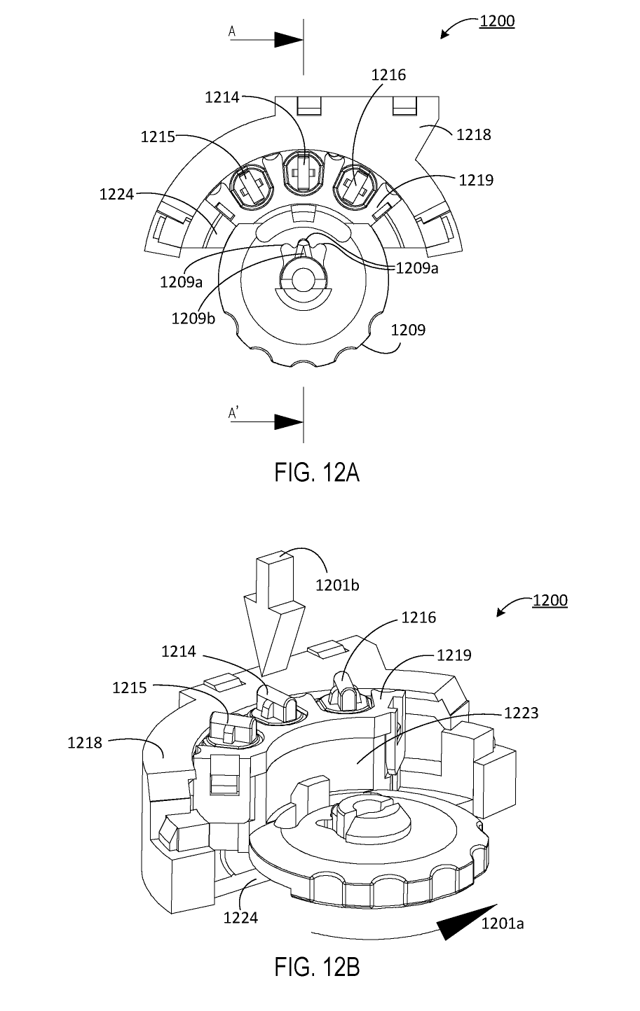

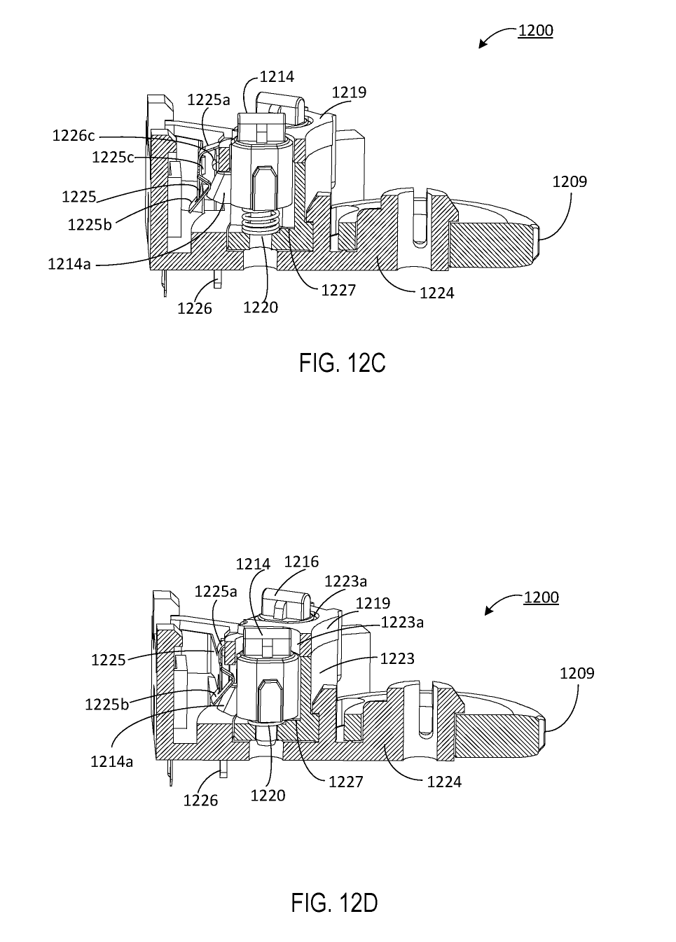

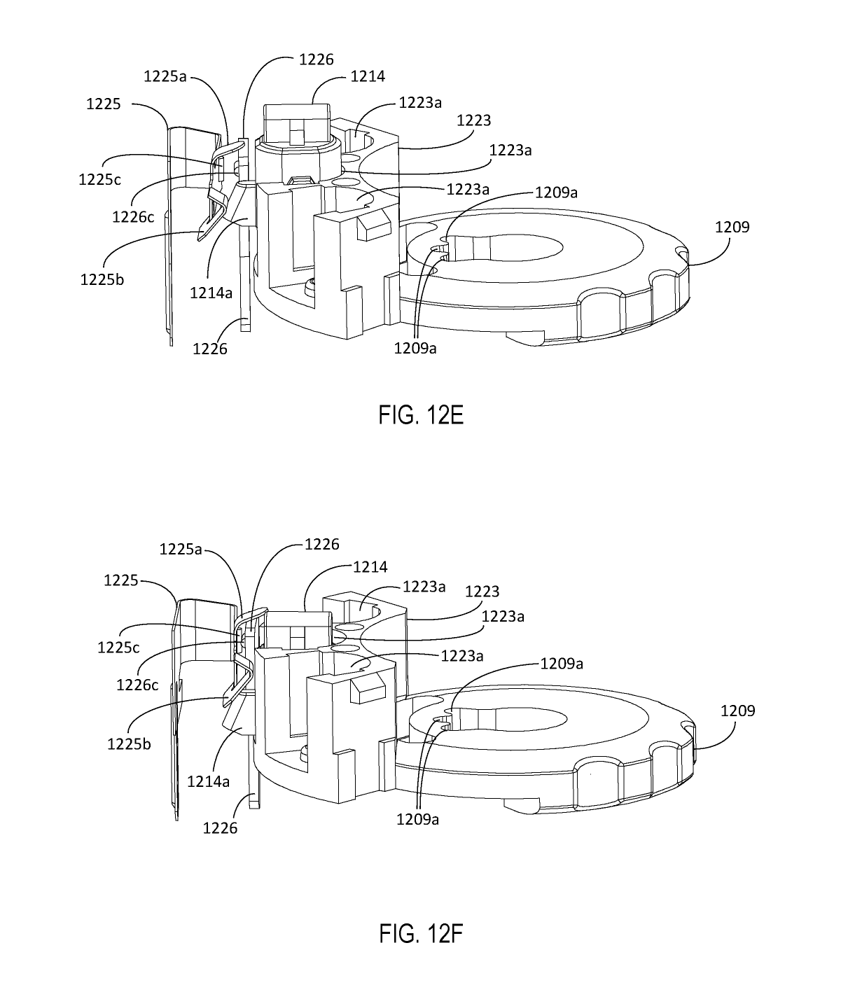

FIG. 12A, FIG. 12B, FIG. 12C, FIG. 12D, FIG. 12E, and FIG. 12F illustrate the workings of some components of a tunable wheel assembly 1200, according to certain embodiments. FIG. 12A shows a housing 1224, a chassis 1218, a rotatable wheel 1209, a stem cover 1219, an A-type stem switch 1214, a B-type stem switch 1215, and a C-type stem switch 1216, according to certain embodiments. FIG. 12A shows that A-type stem switch 1214 is the selected switch setting positioned under the click button on the computer mouse. Rotatable wheel 1209 includes tooth slots 1209a and a tooth 1209b that can be moved from one tooth slot to another by rotating rotatable wheel 1209. Rotatable wheel 1209 can be rotated in order to change the switch settings and tooth 1209b locks the selected stem switch into position. FIG. 12A also shows the cross section line A-A′ that is associated with each of the cross sections shown in FIG. 12C, FIG. 12D, FIG. 12E, and FIG. 12F herein.

FIG. 12B illustrates a top perspective view of the tunable wheel assembly 1200, according to certain embodiments. FIG. 12B shows a rotatable wheel casing 1223, a housing 1224, a chassis 1218, a rotatable wheel 1209, a stem cover 1219, A-type stem switch 1214, B-type stem switch 1215, and C-type stem switch 1216, according to certain embodiments. Rotatable wheel 1209 can be rotated (1201a) in order to position the A-type stem switch 1214 as the operating switch underneath a click button of the computer mouse (click button on computer mouse is not shows in FIG. 12B). When the click button is pressed, an associated post pushes down (1201b) on stem switch 1214 as shown in FIG. 12B.

FIG. 12C and FIG. 12E illustrate a cross sectional view of the tunable wheel assembly 1200 (FIG. 12A, as previously described above, shows the line for cross section A-A′), according to certain embodiments. The cross sectional view shown in FIG. 12C and FIG. 12E illustrate aspects of the A-type stem switch 1214 in conjunction with a sheet metal spring 1225 and contact pin 1226. FIG. 12C and FIG. 12E show A-type stem switch 1214 (for purposes of describing FIG. 12C and FIG. 12E, stem switch 1214 is the operating switch underneath a click button of the computer mouse), a rotatable wheel casing 1223 (with associated slots 1223a for stem switches), a stem cover 1219 (but the stem cover portion around the front half portion A-type stem switch 1214 is removed in order not to obscure the view of the components of A-type stem switch 1214 when working in conjunction with metal sheet spring), and rotatable wheel 1209, according to certain embodiments. FIG. 12C and FIG. 12E also show sheet metal spring 1225 (with an upper ear 1225a, a lower ear 1225b, and a contact point 1225c), stem foot 1214a (associated with stem switch 1214), spring 1220, contact pin 1226 (with associated contact point 1226c), travel limit stopper 1227 (associated with rotatable wheel casing 1223), housing 1224 (shown in FIG. 12C but not in FIG. 12E in order not to obscure the view of the sheet metal spring 1225 and contact pin 1226). Travel limit stopper 1227 limits the travel distance of stem switch 1214. Spring 1220 exerts a spring force against stem switch 1214 when stem switch 1214 is pressed down as described in greater detail below with respect to at least FIG. 12D. FIG. 12C and FIG. 12E show that stem switch 1214 is in the unpressed position. Thus, sheet metal spring ears (1225a, 1225b) push against stem cover 1219 and stem foot 1214a, respectively, and thus prevent contact point 1225c associated with sheet metal spring 1225 from contacting contact point 1226c associated with contact pin 1226. In the unpressed position of the stem switch, the position of stem foot 1214a relative to the position of the lower sheet metal spring ear 1225b affects the click-ratio (tactile effect) of the stem switch.

FIG. 12D and FIG. 12F illustrate the cross sectional view as described above but showing that A-type stem switch 1214 is in the pressed position. Housing 1224, as described previously, is shown in 12D but not shown in FIG. 12F in order not to obscure the view of the sheet metal spring 1225 and contact pin 1226 in FIG. 12F. In the pressed position, stem switch 1214 is pushed down against spring 1220 in slot 1223a (associated with rotating wheel casing 1223), according to certain embodiments. However, travel limit stopper 1227 limits the travel distance of stem switch 1214 in rotating wheel casing 1223. Further, as can be seen FIG. 12D and FIG. 12F, when stem switch 1214 is in the pressed position, stem foot 1214a is lowered in rotating wheel casing 1223. The lowering of stem foot 1214a, in part, allows the sheet metal spring lower ear 1225b to move forward towards the contact pin 1226. Thus, contact point 1225c associated with sheet metal spring 1225 makes contact with contact point 1226c associated with contact pin 1226, as shown in FIG. 12D and FIG. 12F.

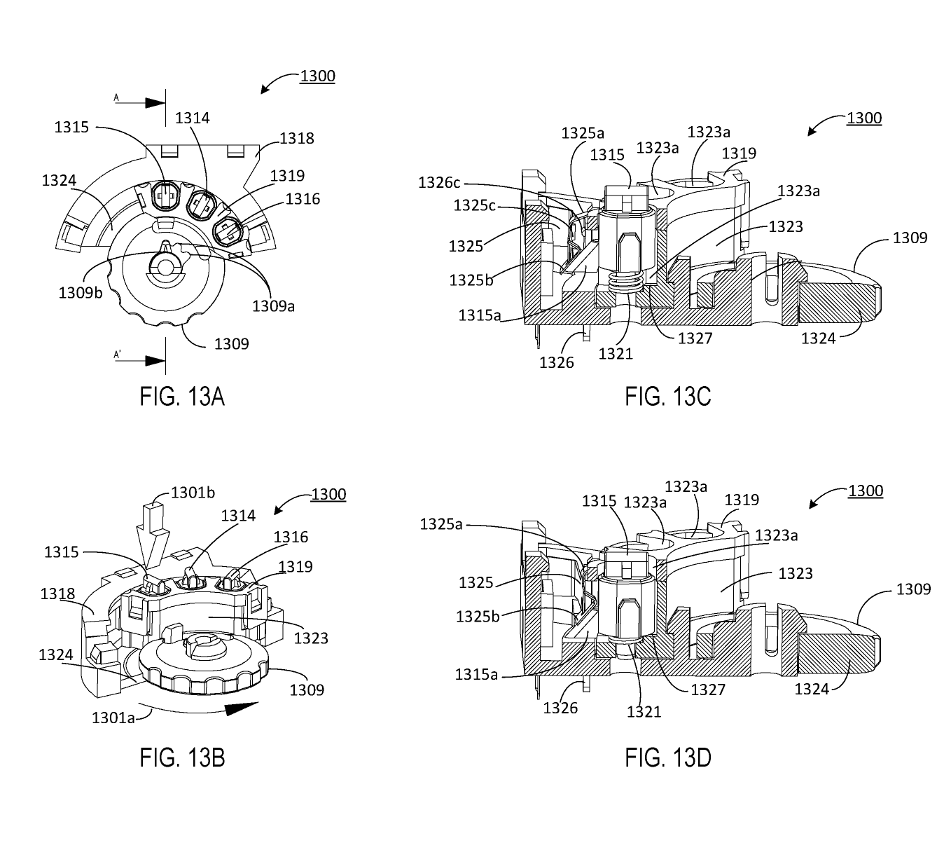

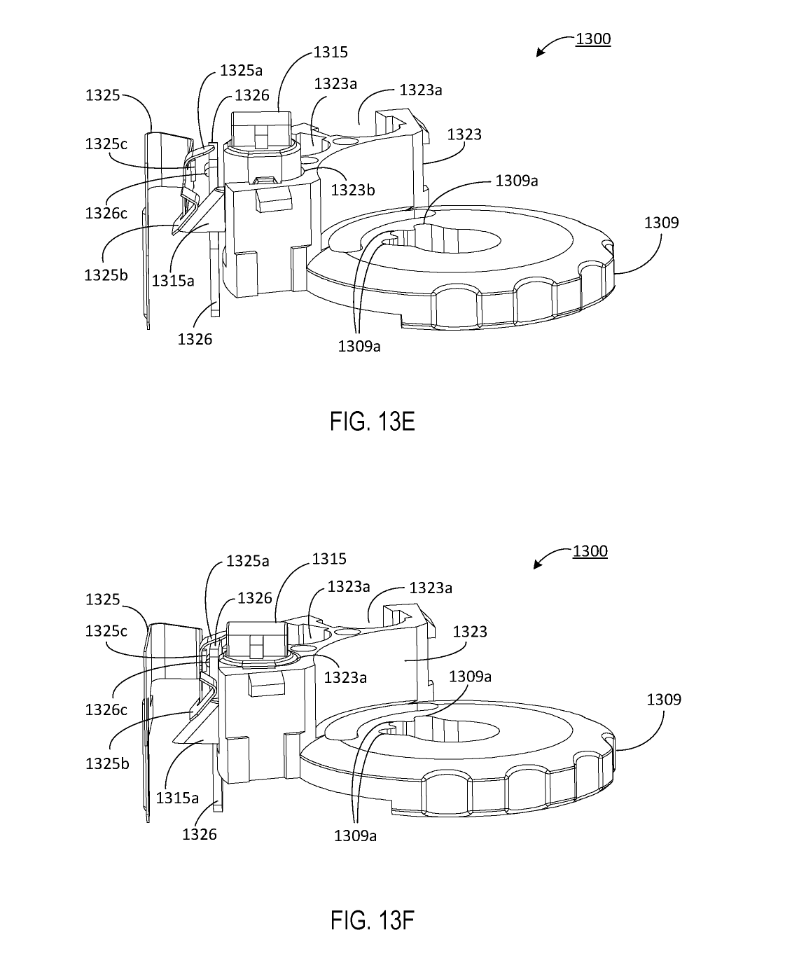

FIG. 13A, FIG. 13B, FIG. 13C, FIG. 13D, FIG. 13E, and FIG. 13F illustrate the workings of some components of a tunable wheel assembly 1300, according to certain embodiments. FIG. 13A shows a housing 1324, a chassis 1318, a rotatable wheel 1309, a stem cover 1319, an A-type stem switch 1314, a B-type stem switch 1315, and a C-type stem switch 1316, according to certain embodiments. FIG. 13A shows that B-type stem switch 1315 is the selected switch setting positioned under the click button on the computer mouse. Rotatable wheel 1309 includes tooth slots 1309a and a tooth 1309b that can be moved from one tooth slot to another by rotating rotatable wheel 1309. Rotatable wheel 1309 can be rotated in order to change the switch settings and tooth 1309b locks the selected stem switch into position. FIG. 13A also shows the cross section line A-A′ that is associated with each of the cross sections shown in FIG. 13C, FIG. 13D, FIG. 13E, and FIG. 13F herein.

FIG. 13B illustrates a top perspective view of the tunable wheel assembly 1300, according to certain embodiments. FIG. 13B shows a rotatable wheel casing 1323, a housing 1324, a chassis 1318, rotatable wheel 1309, a stem cover 1319, A-type stem switch 1314, B-type stem switch 1315, and C-type stem switch 1316, according to certain embodiments. Rotatable wheel 1309 can be rotated (1301a) in order to position the B-type stem switch 1315 as the operating switch underneath a click button of the computer mouse (click button on computer mouse is not shows in FIG. 13B). When the click button is pressed, an associated post pushes down (1301b) on stem switch 1315 as shown in FIG. 13B.

FIG. 13C and FIG. 13E illustrate a cross sectional view of the tunable wheel assembly 1300 (FIG. 13A, as previously described above, shows the line for cross section A-A′), according to certain embodiments. The cross sectional view shown in FIG. 13C and FIG. 13E illustrate aspects of the B-type stem switch 1315 in conjunction with a sheet metal spring 1325 and contact pin 1326. FIG. 13C and FIG. 13E show B-type stem switch 1315 (for purposes of describing FIG. 13C and FIG. 13E, stem switch 1315 is the operating switch underneath a click button of the computer mouse), a rotatable wheel casing 1323 (with associated slots 1323a for stem switches), a stem cover 1319 (but the stem cover portion around the front half portion B-type stem switch 1315 is removed in order not to obscure the view of the components of B-type stem switch 1315 when working in conjunction with metal sheet spring), and rotatable wheel 1309, according to certain embodiments. FIG. 13C and FIG. 13E also show sheet metal spring 1325 (with an upper ear 1325a, a lower ear 1325b, and a contact point 1325c), stem foot 1315a (associated with stem switch 1315), spring 1321, contact pin 1326 (with associated contact point 1326c), travel limit stopper 1327 (associated with rotatable wheel casing 1323), housing 1324 (shown in FIG. 13C but not in FIG. 13E in order not to obscure the view of the sheet metal spring 1325 and contact pin 1326). Travel limit stopper 1327 limits the travel distance of stem switch 1315. Spring 1321 exerts a spring force against stem switch 1315 when stem switch 1315 is pressed down as described in greater detail below with respect to at least FIG. 13D. FIG. 13C and FIG. 13E show that stem switch 1315 is in the unpressed position. Thus, sheet metal spring ears (1325a, 1325b) push against stem cover 1319 and stem foot 1315a, respectively, and thus prevent contact point 1325c associated with sheet metal spring 1325 from contacting contact point 1326c associated with contact pin 1326. In the unpressed position of the stem switch, the position of stem foot 1315a relative to the position of the lower sheet metal spring ear 1325b affects the click-ratio (tactile effect) of the stem switch.

FIG. 13D and FIG. 13F illustrate the cross sectional view as described above but showing that B-type stem switch 1315 is in the pressed position. Housing 1324, as described previously, is shown in 13D but not shown in FIG. 13F in order not to obscure the view of the sheet metal spring 1325 and contact pin 1326 in FIG. 13F, according to certain embodiments. In the pressed position, stem switch 1315 is pushed down against spring 1321 in slot 1323a (associated with rotating wheel casing 1323). However, travel limit stopper 1327 limits the travel distance of stem switch 1315 in rotating wheel casing 1323. Further, as can be seen FIG. 13D and FIG. 13F, when stem switch 1315 is in the pressed position, stem foot 1315a is lowered in rotating wheel casing 1323. The lowering of stem foot 1315a, in part, allows the sheet metal spring lower ear 1325b to move forward towards the contact pin 1326. Thus, contact point 1325c associated with sheet metal spring 1325 makes contact with contact point 1336c associated with contact pin 1326, as shown in FIG. 13D and FIG. 13F.

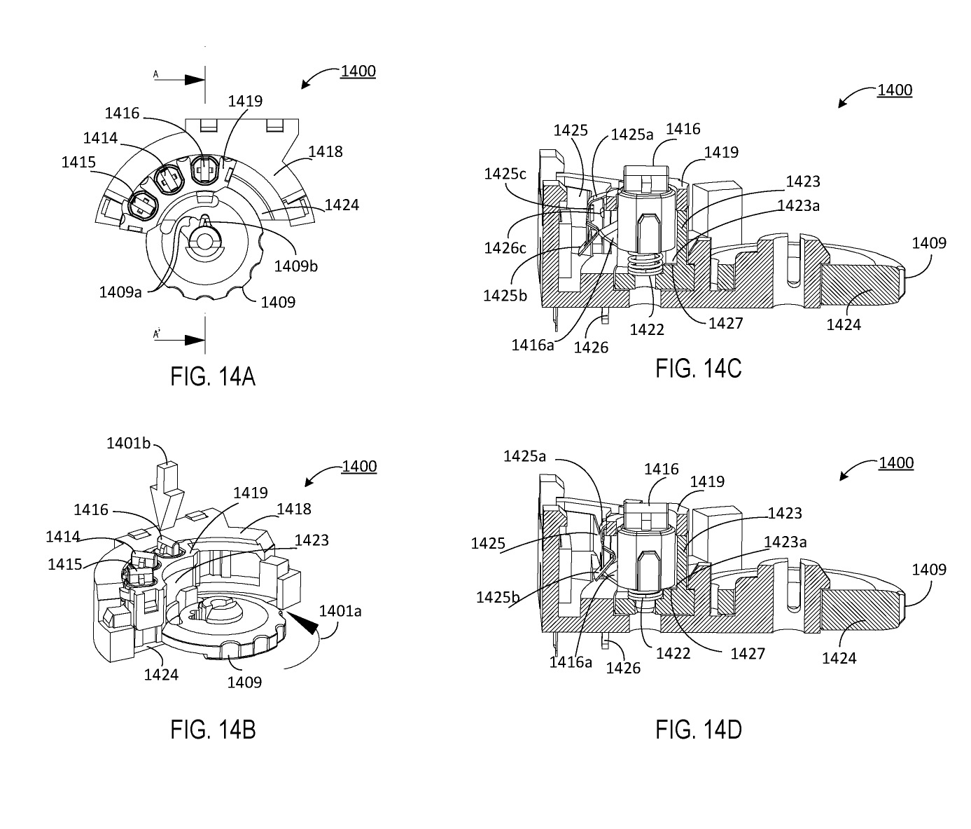

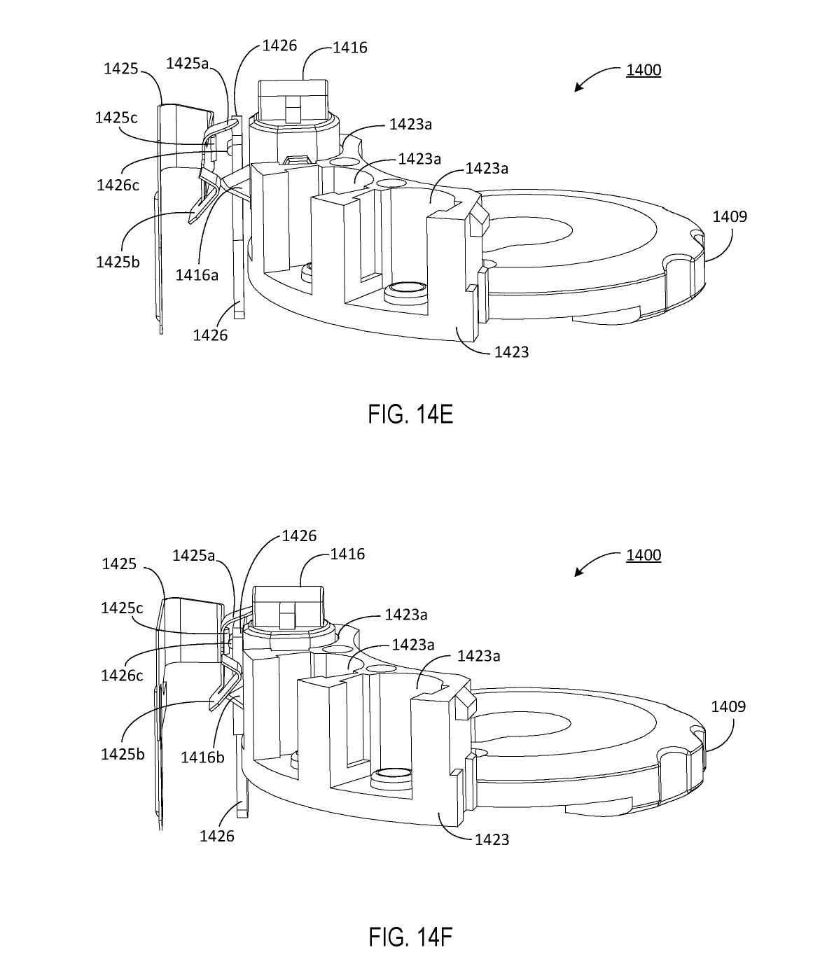

FIG. 14A, FIG. 14B, FIG. 14C, FIG. 14D, FIG. 14E, and FIG. 14F illustrate the workings of some components of a tunable wheel assembly 1400, according to certain embodiments. FIG. 14A shows a housing 1424, a chassis 1418, a rotatable wheel 1409, a stem cover 1419, an A-type stem switch 1414, a B-type stem switch 1415, and a C-type stem switch 1416, according to certain embodiments. FIG. 14A shows that C-type stem switch 1416 is the selected switch setting positioned under the click button on the computer mouse. Rotatable wheel 1409 includes tooth slots 1409a and a tooth 1409b that can be moved from one tooth slot to another by rotating rotatable wheel 1409. Rotatable wheel 1409 can be rotated in order to change the switch settings and tooth 1409b locks the selected stem switch into position. FIG. 14A also shows the cross section line A-A′ that is associated with each of the cross sections shown in FIG. 14C, FIG. 14D, FIG. 14E, and FIG. 14F herein.

FIG. 14B illustrates a top perspective view of the tunable wheel assembly 1400, according to certain embodiments. FIG. 14B shows a rotatable wheel casing 1423, housing 1424, a chassis 1418, rotatable wheel 1409, a stem cover 1419, A-type stem switch 1414, B-type stem switch 1415, and C-type stem switch 1416, according to certain embodiments. Rotatable wheel 1409 can be rotated (1401a) in order to position the C-type stem switch 1416 as the operating switch underneath a click button of the computer mouse (click button on computer mouse is not shows in FIG. 14B). When the click button is pressed, an associated post pushes down (1401b) on stem switch 1416 as shown in FIG. 14B.

FIG. 14C and FIG. 14E illustrate a cross sectional view of the tunable wheel assembly 1400 (FIG. 14A, as previously described above, shows the line for cross section A-A′), according to certain embodiments. The cross sectional view shown in FIG. 14C and FIG. 14E illustrate aspects of the C-type stem switch 1416 in conjunction with a sheet metal spring 1425 and contact pin 1426. FIG. 14C and FIG. 14E show C-type stem switch 1416 (for purposes of describing FIG. 14C and FIG. 14E, stem switch 1416 is the operating switch underneath a click button of the computer mouse), a rotatable wheel casing 1423 (with associated slots 1423a for stem switches), a stem cover 1419 (but the stem cover portion around the front half portion C-type stem switch 1416 is removed in order not to obscure the view of the components of C-type stem switch 1416 when working in conjunction with metal sheet spring), and rotatable wheel 1409, according to certain embodiments. FIG. 14C and FIG. 14E also show sheet metal spring 1425 (with an upper ear 1425a, a lower ear 1425b, and a contact point 1425c), stem foot 1416a (associated with stem switch 1416), spring 1422, contact pin 1426 (with associated contact point 1426c), travel limit stopper 1427 (associated with rotatable wheel casing 1423), housing 1424 (shown in FIG. 14C but not in FIG. 14E in order not to obscure the view of the sheet metal spring 1425 and contact pin 1426). Travel limit stopper 1427 limits the travel distance of stem switch 1416. Spring 1422 exerts a spring force against stem switch 1416 when stem switch 1416 is pressed down as described in greater detail below with respect to at least FIG. 14D. FIG. 14C and FIG. 14E show that stem switch 1416 is in the unpressed position. Thus, sheet metal spring ears (1425a, 1425b) push against stem cover 1419 and stem foot 1416a, respectively, and thus prevent contact point 1425c associated with sheet metal spring 1425 from contacting contact point 1426c associated with contact pin 1426. In the unpressed position of the stem switch, the position of stem foot 1416a relative to the position of the lower sheet metal spring ear 1425b affects the click-ratio (tactile effect) of the stem switch.

FIG. 14D and FIG. 14F illustrate the cross sectional view as described above but showing that C-type stem switch 1416 is in the pressed position, according to certain embodiments. Housing 1424, as described previously, is shown in 14D but not shown in FIG. 14F in order not to obscure the view of the sheet metal spring 1425 and contact pin 1426 in FIG. 14F. In the pressed position, stem switch 1416 is pushed down against spring 1422 in slot 1423a (associated with rotating wheel casing 1423). However, travel limit stopper 1427 limits the travel distance of stem switch 1416 in rotating wheel casing 1423. Further, as can be seen FIG. 14D and FIG. 14F, when stem switch 1416 is in the pressed position, stem foot 1416a is lowered in rotating wheel casing 1423. The lowering of stem foot 1416a, in part, allows the sheet metal spring lower ear 1425b to move forward towards the contact pin 1426. Thus, contact point 1425c associated with sheet metal spring 1425 makes contact with contact point 1426c associated with contact pin 1426, as shown in FIG. 14D and FIG. 14F.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A computer mouse comprising:
a plurality of tunable switch assemblies, wherein a tunable switch assembly of the plurality of tunable switch assemblies comprises:
a plurality of tunable switches, wherein each tunable switch of the plurality of tunable switches is distinct from any other tunable switch in the plurality of tunable switches in the tunable switch assembly; and
a rotatable wheel casing that houses the plurality of tunable switches, wherein the rotatable wheel casing includes a rotatable wheel for moving, into an operational position, a selected tunable switch selected from the plurality of tunable switches.

2. The computer mouse of claim 1, wherein each tunable switch of the plurality of tunable switches is associated with a corresponding set of tactile and auditory characteristics.

3. The computer mouse of claim 1, wherein each tunable switch of the plurality of tunable switches is associated with at least a subset of a set of characteristics, the set of characteristics including: total travel distance of each tunable switch within the rotatable wheel casing, operating distance of each tunable switch, operating force of one or more springs associated with each tunable switch, sound effects associated with each tunable switch, and a click-ratio associated with each tunable switch.

4. The computer mouse of claim 1, wherein each tunable switch of the plurality of tunable switches is associated with either a linear tactile effect or a non-linear tactile effect.

5. The computer mouse of claim 1, wherein a tactile effect corresponding to each tunable switch of the plurality of tunable switches is associated with at least a subset of: a switch stem length, a switch spring force, a switch stem foot shape and slope, a position of a switch stem foot on a corresponding switch stem, and a position of a travel limit stopper for limiting travel of a corresponding tunable switch within the rotatable wheel casing.

6. The computer mouse of claim 1, wherein a position of a stem foot associated with a corresponding tunable switch of the plurality of tunable switches relative to a position of an associated contact spring affects a click-ratio of the corresponding tunable switch.

7. The computer mouse of claim 1, wherein a shape of a stem foot associated with a corresponding tunable switch of the plurality of tunable switches affects a click-ratio of the corresponding tunable switch.
